(19) United States
(12) Patent Application Publication
(10) Pub. No.: US 2004/0267531 A1
(43) Pub. Date: Dec. 30, 2004

(54) Method and system for providing text-to-speech instant messaging

(76) Inventors: Stephen R. Whynot, Richardson, TX (US); F. Randall Murray II, McKinney, TX (US); Marc I. Hebert, Dallas, TX (US)

Correspondence Address: DOCKET CLERK, P.O. DRAWER 800889, DALLAS, TX, 75380, US

(21) Appl. No.: 10/610,517

(22) Filed: Jun. 30, 2003

(51) Int. Cl. G10L 13/00

(52) U.S. Cl. 704/260

(57) ABSTRACT

A method for providing text-to-speech instant messaging is provided. The method includes receiving a convertible instant message from a sender using a text communication device for a recipient using a speech communication device. The convertible instant message is converted from text to speech by a text-to-speech converter in a media application server. The media application server provides the converted instant message, along with response options, to the recipient. The recipient selects one of the response options, and the media application server sends a response message to the sender that includes the response option selected by the recipient.

### TECHNICAL FIELD

The present invention relates generally to communication systems and, more particularly, to a method and system for providing text-to-speech instant messaging.

### BACKGROUND

Instant messaging, in which two or more parties communicate with each other through text messages sent back and forth in real time, is becoming more and more popular. In addition to personal computers, many devices such as wireless personal digital assistants can be enabled to send and receive instant messages. However, with conventional instant messaging systems, all parties communicating through instant messaging have to have access to such an enabled device.

### SUMMARY

In accordance with the present invention, a method and system for providing text-to-speech instant messaging are provided that substantially eliminate or reduce disadvantages and problems associated with conventional methods and systems.

According to one embodiment of the present invention, a method for providing text-to-speech instant messaging is provided that includes receiving a convertible instant message for a recipient from a sender. The convertible instant message is converted from text to speech and provided, along with response options, to the recipient. The recipient selects one of the response options, and a response message is sent to the sender that includes the response option selected by the recipient.

According to another embodiment of the present invention, a system for providing text-to-speech instant messaging is provided that includes a text communication device, a speech communication device, and a media application server. The media application server is coupled to the text and speech communication devices through a network. The media application server is able to receive a convertible instant message from the text communication device, to contact the speech communication device, to convert the convertible instant message from text to speech, and to provide the converted instant message to the speech communication device. The media application server is also able to provide response options to the speech communication device, to receive from the speech communication device a response selected from one of the response options, and to send to the text communication device a response message that includes the selected response option.

### BRIEF DESCRIPTION OF THE DRAWINGS

For a more complete understanding of the present invention and its advantages, reference is now made to the following description taken in conjunction with the accompanying drawings, wherein like reference numerals represent like parts, in which:

FIG. 1 is a block diagram illustrating a communication system for providing text-to-speech instant messaging in accordance with one embodiment of the present invention;

FIG. 2 is a block diagram illustrating the Media Application Server of FIG. 1 in accordance with one embodiment of the present invention; and

FIG. 3 is a flow diagram illustrating a method for providing text-to-speech instant messaging in the communication system of FIG. 1 in accordance with one embodiment of the present invention.

### DETAILED DESCRIPTION OF THE INVENTION

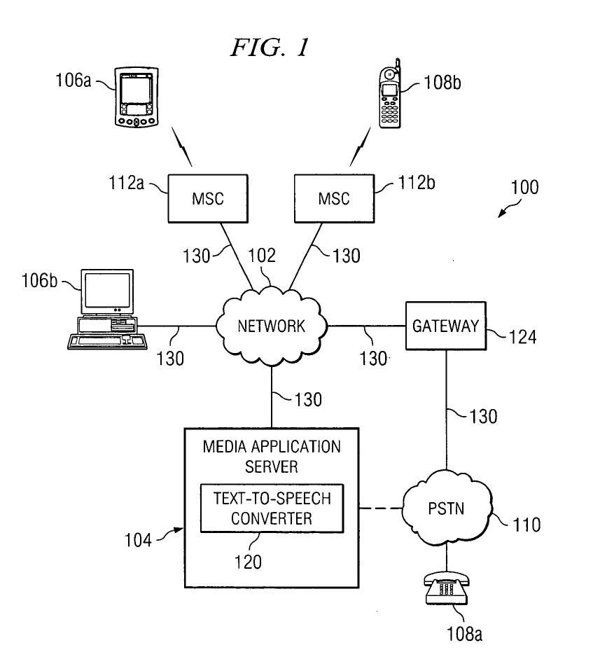

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged communication system.

FIG. 1 is a block diagram illustrating a communication system 100 in accordance with one embodiment of the present invention. As described in more detail below, the communication system 100 is operable to provide text-to-speech instant messaging, which allows one party to use text to communicate a spoken message to another party. As used herein, an “instant message” means a message that a first party generates at a first device and that is sent when it is completed from the first device to a second device for communication to a second party at the time it is received by the second device.

The communication system 100 includes a network 102, a Media Application Server (“MAS”) 104, a plurality of text communication devices 106, and a plurality of speech communication devices 108. The communication system 100 may also include at least one public telephone network 110, such as a public switched telephone network (“PSTN”), and one or more mobile switching centers (“MSC”) 112.

The network 102 is coupled to the Media Application Server 104 and the PSTN 110 and may also be coupled to one or more of the text communication devices 106 and/or the mobile switching centers 112. In this document, the term “couple” refers to any direct or indirect communication between two or more components, whether or not those components are in physical contact with each other.

The network 102 is operable to facilitate communication between components of the communication system 100. For example, the network 102 may communicate Internet Packets (“IP”), frame relay frames, Asynchronous Transfer Mode (“ATM”) cells, or other suitable information between network addresses. The network 102 may include one or more local area networks (“LANs”), metropolitan area networks (“MANs”), wide area networks (“WANs”), all or portions of a global network such as the Internet, or any other communication system or systems at one or more locations.

The Media Application Server 104 includes a text-to-speech converter 120 that is operable to receive text data and generate speech data based on the text data. The Media Application Server 104 is operable to receive a convertible instant message from a text communication device 106, convert the instant message from text to speech with the text-to-speech converter 120, and send the converted instant message to a speech communication device 108.

A convertible instant message comprises an instant message in text form that identifies the Media Application Server 104 as a destination and also identifies the recipient for the Media Application Server 104 so that the Media Application Server 104 may send the message to the recipient after conversion. For example, the message may include a telephone number for the recipient's speech communication device 108. The identification of the recipient may be provided in a specified field, such as a subject line in an e-mail, or may be indicated by predefined characters. A converted instant message comprises the instant message in speech form.

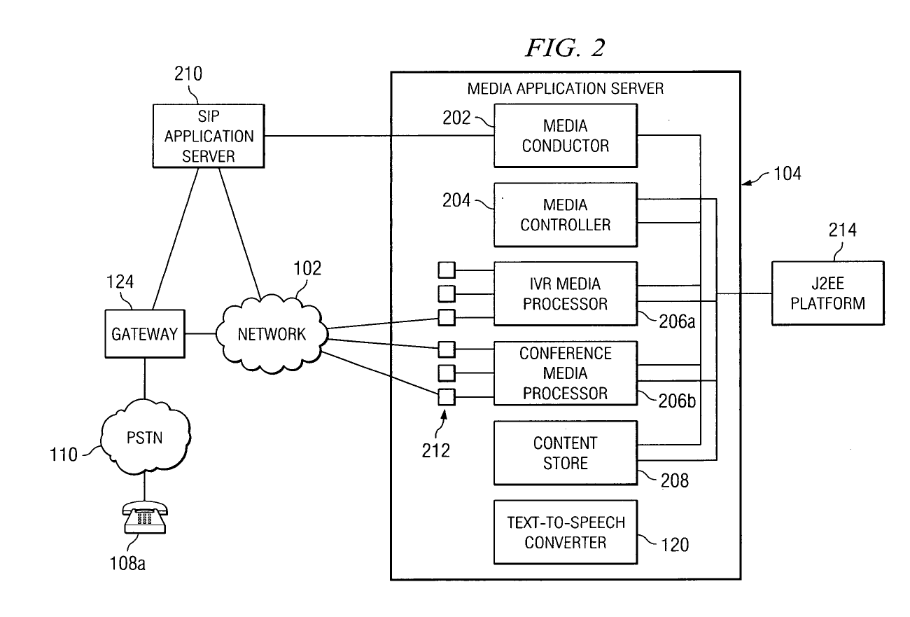

One embodiment of the Media Application Server 104 is shown in FIG. 2, which is described below, and in co-pending U.S. patent application Ser. No. ______ entitled “DISTRIBUTED ARCHITECTURE SUPPORTING COMMUNICATION SESSIONS IN A COMMUNICATION SYSTEM AND METHOD” and filed on the same date herewith, and identified by attorney docket number 15996RRUS01U (NORT10-00304) which is incorporated by reference.

Any portion or all of the Media Application Server 104, including the text-to-speech converter 120, may comprise logic encoded in media. The logic comprises functional instructions for carrying out program tasks. The media comprises computer disks or other computer-readable media, application-specific integrated circuits, field-programmable gate arrays, digital signal processors, other suitable specific or general purpose processors, transmission media or other suitable media in which logic may be encoded and utilized.

Each text communication device 106 may comprise any device that is operable to communicate text data to the Media Application Server 104 through the network 102. It will be understood that the text communication devices 106 may also be operable to communicate any other suitable data without departing from the scope of the present invention.

As shown in the illustrated embodiment, the text communication devices 106 may comprise wireless communication devices 106a, such as personal digital assistants and the like, that are operable to communicate with the network 102 through a mobile switching center 112a, personal computers 106b that are operable to communicate directly with the network 102, and/or any other suitable communication device.

Each speech communication device 108 may comprise any device that is operable to communicate speech data received from the Media Application Server 104 through the network 102. It will be understood that the speech communication devices 108 may also be operable to communicate any other suitable data without departing from the scope of the present invention.

As shown in the illustrated embodiment, the speech communication devices 108 may comprise conventional telephones 108a that are operable to communicate with the network 102 through the PSTN 110, wireless telephones 108b that are operable to communicate with the network 102 through a mobile switching center 112b, and/or any other suitable communication device. The network 102 and the PSTN 110 may use different protocols to communicate. Thus, in order to facilitate communication between these networks 102 and 110, a gateway 124 that is operable to translate between the different protocols may be used to couple the network 102 to the PSTN 110.

In addition, the Media Application Server 104 may be coupled to the PSTN 110 or the gateway 124. For this embodiment, the Media Application Server 104 is operable to place calls to speech communication devices 108 without routing them through the network 102.

The various components of the communication system 100 may be coupled to each other via communication lines 130. The communication lines 130 may be any type of communication links capable of supporting data transfer. In one embodiment, the communication lines 130 may comprise, alone or in combination, Integrated Services Digital Network (“ISDN”), Asymmetric Digital Subscriber Line (“ADSL”), T1 or T3 communication lines, hardwire lines, wireless links, or telephone links. It will be understood that the communication lines 130 may comprise other suitable types of data communication links. The communication lines 130 may also connect to a plurality of intermediate servers (not illustrated in FIG. 1) between the components of the communication system 100. For example, the personal computer 106b may be coupled to the network 102 through an e-mail server.

FIG. 2 is a block diagram illustrating the Media Application Server 104 in accordance with one embodiment of the present invention. Thus, although the following describes the Media Application Server 104 in connection with the communication system 100, it will be understood that the Media Application Server 104 may be included as a part of any other suitable system without departing from the scope of the present invention.

In the illustrated embodiment, the Media Application Server 104 includes a media conductor 202, a media controller 204, two media processors 206a-b, and a content store 208, in addition to the text-to-speech converter 120.

The media conductor 202 is operable to process signaling messages received by the Media Application Server 126. For example, a communication devices 112 may communicate the signaling messages directly (or via a gateway, which serves as an entrance/exit into a communications network) to the Media Application Server 126. In other embodiments, the communication devices 112 communicate signaling messages indirectly to the Media Application Server 126, such as when a Session Initiation Protocol (“SIP”) application server 210 (that received a request from a device 112) sends the signaling messages to the media conductor 202 on behalf of the communication device 112. The communication devices 112 may communicate directly with the SIP application server 210 or indirectly through a gateway, such as gateway 134. The media conductor 202 processes the signaling messages and communicates the processed messages to the media controller 204. As particular examples, the media conductor 202 may implement SIP call control, parameter encoding, and media event package functionality.

The media controller 204 is operable to manage the operation of the Media Application Server 126 to provide services to the communication devices 112 and/or other devices such as video clients and the like. For example, the media controller 204 may receive processed SIP requests from the media conductor 202. The media controller 204 may then select the appropriate media processor 206 to handle each of the calls, enforce licenses controlling how the Media Application Server 126 can be used, and control negotiations based on the licenses. The negotiations may include identifying the CODEC to be used to encode and decode audio or video information during a call and/or other suitable services.

The media processors 206a-b are operable to handle the exchange of audio and/or video information between clients involved in a call. For example, a media processor 206 may receive audio and video information from one client involved in a call, process the information as needed, and forward the information to at least one other client involved in the call. The audio and video information may be received through one or more ports 212, which couple the media processors 206a-b to the network 102. Each port 212 may comprise any suitable structure that is operable to facilitate communication between the Media Application Server 126 and the network 102.

In the illustrated embodiment, each media processor 206 provides different functionality in the Media Application Server 126. For example, the first media processor 206a may provide interactive voice response (“IVR”) functionality in the Media Application Server 126. As particular examples, the media processor 206a may support a voice mail function that is able to record and play messages and/or an auto-attendant function that is able to provide a menu to direct callers to particular destinations based on their selections.

According to one embodiment, the media processor 206a is operable to receive and interpret dual-tone multi-frequency (“DTMF”) tones from speech communication devices 108. DTMF tones are used in the tone dialing system in which two non-harmonic related frequencies are generated simultaneously by the speech communication device in order to identify a number dialed by the user of the speech communication device 108. However, it will be understood that this functionality, if used for a specific embodiment, may be included in any other suitable component of the Media Application Server 104 without departing from the scope of the present invention.

The media processor 206b may provide conferencing functionality in the Media Application Server 104, such as by facilitating the exchange of audio and/or video information between users.

The content store 208 is operable to provide access to content used by the various components of the communication system 100. For example, the content store 208 may provide access to stored voice mail messages, access codes used to initiate or join conference calls and/or any other suitable information. The content store 208 may comprise a conventional database or any other suitable data storage facility.

According to one embodiment, a Java 2 Enterprise Edition (“J2EE”) platform 214 may be coupled to the Media Application Server 126. The J2EE platform 214 is operable to allow the Media Application Server 126 to retrieve information used to provide services to users in the communication system 100. For example, the J2EE platform 214 may provide audio announcements used by the interactive voice response media processor 206a. The J2EE platform 214 represents one possible device used to serve audio or other information to the Media Application Server 126. However, it will be understood that any suitable device may be used to provide information to the Media Application Server 126 without departing from the scope of the present invention.

Although FIG. 2 illustrates one example of a Media Application Server 126, various changes may be made to FIG. 2 while maintaining the advantages and functionality recited herein. For example, any number of media processors 206a-b may be used in the Media Application Server 126. Also, the functional divisions shown in FIG. 2 are for illustration only. Various components can be combined or omitted or additional components can be added according to particular functional designations or needs.

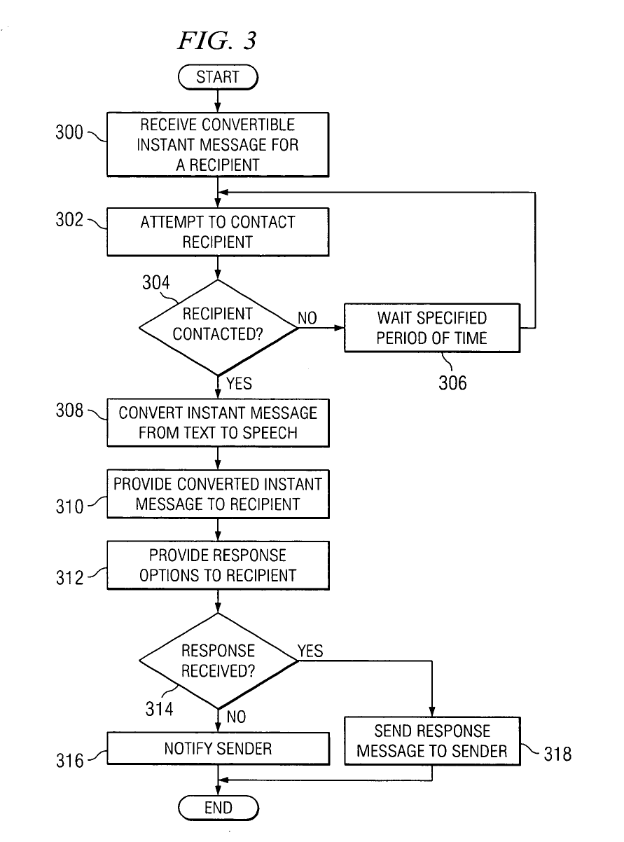

FIG. 3 is a flow diagram illustrating a method for providing text-to-speech instant messaging in accordance with one embodiment of the present invention. The method begins at step 300 where the Media Application Server 104 receives a convertible instant message for a recipient from a sender's text communication device 106. As defined above in connection with FIG. 1, this convertible instant message identifies the Media Application Server 104 as a destination and also identifies the recipient for the Media Application Server 104 so that the Media Application Server 104 may send the message to the recipient after conversion. For example, the message may include a telephone number for the recipient's speech communication device 108. At step 302, the Media Application Server 104 attempts to contact the recipient by placing a call to the recipient's speech communication device 108.

At decisional step 304, the Media Application Server 104 makes a determination regarding whether or not the recipient has been contacted. For example, the Media Application Server 104 may determine whether or not the recipient has answered his or her telephone. If the recipient has not been contacted, the method follows the No branch from decisional step 304 to step 306.

At step 306, the Media Application Server 104 may wait a specified period of time before returning to step 302 and attempting to contact the recipient again. Thus, for example, if the recipient does not answer his or her telephone or if a busy signal is received, the Media Application Server 104 may attempt to place the call again after the specified period of time has passed.

According to one embodiment, the Media Application Server 104 may repeat the attempt to contact the recipient in this way a specified number of times, after which the sender of the convertible instant message is notified that the recipient is unavailable. According to another embodiment, the Media Application Server 104 may notify the sender of the convertible instant message that the recipient is unavailable after only one failed attempt to contact the recipient.

For either of these embodiments, the sender may resend the convertible instant message at a later time or the Media Application Server 104 may begin attempting to contact the recipient again after a longer specified period of time has passed, based on how the Media Application Server 104 is implemented.

Returning to decisional step 304, if the Media Application Server 104 has been able to contact the recipient, the method follows the Yes branch from decisional step 304 to step 308. At step 308, the text-to-speech converter 120 converts the instant message from text to speech by generating an audio stream based on the text of the message.

At step 310, the Media Application Server 104 provides the audio stream comprising the converted instant message to the recipient. For example, the audio stream may be sent from the Media Application Server 104, through the network 102, the gateway 124, and the PSTN 110, to the recipient's telephone 108a where the recipient may hear the speech form of the message. It will be understood that the message may be sent through any suitable path in order to reach the recipient's speech communication device 108.

For a particular embodiment, the Media Application Server 104 may provide the audio stream comprising the converted instant message to a messaging system, such as voice mail, when the recipient is unavailable to hear the converted instant message.

At step 312, the Media Application Server 104 may provide response options to the recipient through the speech communication device 108. For one embodiment, the Media Application Server 104 may send an audio stream to the recipient that states a plurality of response options and informs the recipient how to choose between the response options.

For example, the recipient may be providing with the following response options: “If you would like to respond ‘yes,’ please press or say 1. If you would like to respond ‘no,’ please press or say 2.” For this example, as described above in connection with FIG. 2, the Media Application Server 104 is operable to receive the DTMF tone associated with the number dialed as a response and to interpret the tone as corresponding to a particular response. However, it will be understood that the response options may be in any suitable format and that any suitable number of response options may be provided to the recipient without departing from the scope of the present invention.

For a particular embodiment, the sender of the convertible instant message may be given the option of customizing the response options for the recipient. When the sender wants to customize the options instead of using the default options, the sender may enter the customized response options in the text of the convertible instant message. The customized response options may be indicated by predefined characters or in any other suitable manner. For this embodiment, the text-to-speech converter 120 converts the customized response options from text to speech by generating an audio stream based on the text comprising the customized response options, and the Media Application Server 104 provides the audio stream comprising the speech form of the customized response options to the recipient.

For example, the recipient may be provided with the following customized response options: “If you want me to pick up the dog from the vet, please press or say 1. If you will pick up the dog from the vet, please press or say 2.” For this example, the customized response options provided by the sender may comprise “you want me to pick up the dog from the vet” and “you will pick up the dog from the vet,” with the Media Application Server 104 providing the remainder of the response options, such as “if” and “please press or say 1.” However, it will be understood that the customized response options may comprise any other suitable form. In addition, it will be understood that any suitable number of customized response options may be provided to the recipient.

At decisional step 314, the Media Application Server 104 makes a determination regarding whether or not a response has been received from the recipient. If no response has been received, the method follows the No branch from decisional step 314 to step 316. At step 316, the Media Application Server 104 may notify the sender that no response was received, at which point the method comes to an end. The notification includes a text message sent from the Media Application Server 104 to the sender's text communication device 106.

Returning to decisional step 314, if a response has been received, the method follows the Yes branch from decisional step 314 to step 318. At step 318, the Media Application Server 104 sends a response message to the sender, at which point the method comes to an end. The response message includes a text message sent from the Media Application Server 104 to the sender's text communication device 106 and includes the response option received from the recipient. For example, the response message may include “1,” “Yes,” “You will pick up the dog from the vet,” or any other suitable text to indicate which response option was received.

It may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and if the term “controller” is utilized herein, it means any device, system or part thereof that controls at least one operation, such a device may be implemented in hardware, firmware or software, or some combination of at least two of the same. It should be noted that the functionality associated with any particular controller may be centralized or distributed, whether locally or remotely.

Although the present invention has been described with several embodiments, various changes and modifications may be suggested to one skilled in the art. It is intended that the present invention encompass such changes and modifications as fall within the scope of the appended claims.

What is claimed is:

1. A method for providing text-to-speech instant messaging, comprising:
receiving a convertible instant message for a recipient from a sender;
contacting the recipient;
converting the convertible instant message from text to speech; and
providing the converted instant message to the recipient.

2. The method of claim 1, further comprising providing response options to the recipient.

3. The method of claim 2, further comprising receiving a response from the recipient, the response comprising one of the response options.

4. The method of claim 3, further comprising sending a response message to the sender, the response message comprising the response received from the recipient.

5. The method of claim 2, further comprising, when no response is received from the recipient, notifying the sender that no response was received.

6. The method of claim 2, the response options comprising customized response options.

7. The method of claim 1, further comprising attempting to contact the recipient a specified number of times when the recipient is unavailable.

8. The method of claim 6, further comprising, when the recipient is unavailable, notifying the sender that the recipient is unavailable.

9. A system for providing text-to-speech instant messaging, comprising:
a text communication device;
a speech communication device;
a media application server coupled to the text and speech communication devices through a network, the media application server operable to receive a convertible instant message from the text communication device, to contact the speech communication device, to convert the convertible instant message from text to speech, and to provide the converted instant message to the speech communication device.

10. The system of claim 9, the media application server further operable to provide response options to the speech communication device.

11. The system of claim 10, the media application server further operable to receive a response from the speech communication device, the response comprising one of the response options, and to send a response message to the text communication device, the response message comprising the response received from the speech communication device.

12. The system of claim 9, the media application server further operable, when a user of the speech communication device is unavailable, to attempt to contact the speech communication device a specified number of times and to notify the sender that the user of the speech communication device is unavailable.

13. A system for providing text-to-speech instant messaging, comprising:
a computer-readable medium; and
logic stored on the computer-readable medium, the logic operable to receive a convertible instant message for a recipient from a sender, to contact the recipient, to convert the convertible instant message from text to speech, and to provide the converted instant message to the recipient.

14. The system of claim 1, the logic further operable to provide response options to the recipient.

15. The system of claim 14, the logic further operable to receive a response from the recipient, the response comprising one of the response options.

16. The system of claim 15, the logic further operable to send a response message to the sender, the response message comprising the response received from the recipient.

17. The system of claim 14, the logic further operable, when no response is received from the recipient, to notify the sender that no response was received.

18. The system of claim 14, the response options comprising customized response options.

19. The system of claim 13, the logic further operable to attempt to contact the recipient a specified number of times when the recipient is unavailable.

20. The system of claim 19, the logic further operable, when the recipient is unavailable, to notify the sender that the recipient is unavailable.

21. A media application server coupled to a text communication device and to a speech communication device, the media application server operable to receive a convertible instant message from the text communication device, to contact the speech communication device, to convert the convertible instant message from text to speech, and to provide the converted instant message to the speech communication device.

22. The media application server of claim 21, further operable to provide response options to the speech communication device.

23. The media application server of claim 22, further operable to receive a response from the speech communication device, the response comprising one of the response options, and to send a response message to the text communication device, the response message comprising the response received from the speech communication device.

24. The media application server of claim 21, further operable, when a user of the speech communication device is unavailable, to attempt to contact the speech communication device a specified number of times and to notify the sender that the user of the speech communication device is unavailable.
